(19) United States
(12) Patent Application Publication
(10) Pub. No.: US 2019/0333696 A1
(43) Pub. Date: Oct. 31, 2019

(54) NEAR NET SHAPE MANUFACTURING OF MAGNETS WITH PHOTOSENSITIVE SLURRY

(71) Applicant: GM GLOBAL TECHNOLOGY OPERATIONS LLC, Detroit, MI (US)

(72) Inventor: Yucong Wang, West Bloomfield, MI (US)

(21) Appl. No.: 15/964,719

(22) Filed: Apr. 27, 2018

(51) Int. Cl. H01F 41/02; B22F 7/00; B22F 7/02; B22F 3/15; B22F 1/00

(52) U.S. Cl. CPC H01F 41/0293; H01F 41/0273; B22F 7/008; B22F 7/02; B22F 3/15; B22F 2003/247; B22F 1/0088; B22F 2202/05; B22F 2301/355; B22F 2998/10; B22F 1/0074

(57) ABSTRACT

A magnet and a method of forming the magnet are provided. The method includes forming a slurry comprising magnetic powder material and photopolymerizing material and creating raw layers from the slurry. Each layer is cured by electromagnetic radiation prior to forming another layer on the most recent cured layer. The layers are attached together. The method may also include applying a magnetic field to each raw layer while curing the layer, to orient the magnetic powder material in a desired direction.

### FIELD

The present disclosure relates generally to permanent magnets and methods of forming isotropic or anisotropic permanent magnets, which may be used in electric motors, wind mills, electric bikes, and appliances.

### INTRODUCTION

Permanent magnets have been widely used in a variety of devices, including traction electric motors for hybrid and electric vehicles, wind mills, air conditioners and other mechanized equipment. Such permanent magnets may be ferrite, Nd—Fe—B, CmCo, CmFeN, Alnico, etc.

For Nd—Fe—B magnets, the manufacturing processes typically begin with the initial preparation, including inspection and weighing of the starting materials for the desired material compositions. The materials are then vacuum induction melted and strip cast to form thin pieces (less than one mm) of several centimeters in size. This is followed by hydrogen decrepitation, where the thin pieces absorb hydrogen at about 25° C. to about 300° C. for about 5 to about 20 hours, dehydrogenated at about 200° C. to about 400° C. for about 3 to about 25 hours, and then subjected to hammer milling and grinding and/or mechanical pulverization or nitrogen milling (if needed) to form fine powder suitable for further powder metallurgy processing. This powder is typically screened for size classification and then mixed with other alloying powders for the final desired magnetic material composition.

In one process, the magnetic powder is mixed with binders to make green parts (typically in the form of a cube) through a suitable pressing operation in a die. The powder may be weighed prior to its formation into a cubic block or other shape. The shaped part is then vacuum bagged and subjected to isostatic pressing, after which it is sintered (for example, at about 800° C. to about 1100° C. for about 1 to about 30 hrs in vacuum) and aged, if needed, (for example, at about 300° C. to about 700° C. for about 5 to about 20 hours in vacuum). Typically, a number of blocks totaling about 100 kg to about 800 kg undergo sintering at the same time as a batch.

The magnet pieces are then cut and machined to the final shape from the larger block based on the desired final shape for the magnets. The magnet pieces are then surface treated, if desired. A cutting machine having numerous thin blades is used to cut desired shapes from the magnet block. Much of the material is lost in the cutting operation, and the thin blades require maintenance. The cutting and machining process to create the magnets having the desired shape typically results in a relatively large amount of material loss, where the yield is typically about 55 to 75 percent (i.e., about 25 to 45 percent loss of the material).

The high material loss during manufacturing and the machining operation have greatly increased the cost of the finished rare earth element magnets. This cost has been exacerbated by a dramatic rise in the price of the raw rare earth metals in the past several years. As such, there are significant problems associated with producing cost-effective magnets that contain rare earth materials.

### SUMMARY

The present disclosure provides a novel method of producing magnets that includes printing magnetic powder material into a desired final shape of the magnet by printing a series of thin layers of magnetic powder material into a three-dimensional shape that does not require the magnet to be machined into another final shape. This results in a savings of material that is typically lost through the cutting and machining process of the magnet.

To orient the magnetic powder material in a desired direction, a magnetic field may be applied. Creating layers of magnetic powder material under a magnetic field may result in magnetic material moving substantially due to the magnetic field. The present disclosure provides a slurry including magnetic powder material and a photosensitive resin, or a photopolymer, wherein the slurry form of the material maintains the powder intact, and which can then be cured with electromagnetic radiation, such as a light source, to harden layers of the magnet layer by layer.

In one form, which may be combined with or separate from the other forms disclosed herein, a method of forming a magnet is provided. The method includes forming a slurry comprising magnetic powder material and photopolymerizing material. The method then includes creating a raw first layer from the slurry and curing the raw first layer with electromagnetic radiation to form a cured first layer. After curing the raw first layer, the method includes creating a raw second layer from the slurry in contact with the cured first layer and curing the raw second layer with electromagnetic radiation to form a cured second layer, where the cured second layer is attached to the cured first layer.

Additional features may be provided, including but not limited to the following: applying a magnetic field to the raw first layer while curing the raw first layer; applying a magnetic field to the raw second layer while curing the raw second layer; wherein applying the magnetic field substantially orients the magnetic powder material in a desired direction; disposing a plurality of additional layers, layer by layer, onto the cured second layer; each additional layer being formed from the slurry; in between disposing each additional layer, curing with light a most recent disposed additional layer to form a plurality of attached cured layers; the slurry further comprising an organic-based solvent; the electromagnetic radiation being visible light; providing the visible light with a light-emitting diode (LED); providing a base; providing a flat shallow vat holding the slurry while the slurry layer of several micrometers to one millimeter is evenly applied on the flat vat with a sharp knife; lowering the base toward the slurry and touching the slurry to dispose the raw first layer onto the base prior to curing the raw first layer; lifting the base after curing the raw first layer with the desired curing shape which is an image of the electromagnetic radiation formed by the computer aided design (CAD) input for the magnet; removing the residual slurry, and then applying a new layer of slurry of about the same thickness of the first layer; lowering the base toward and touching the slurry to dispose the raw second layer onto the cured first layer prior to curing the raw second layer; lifting the base after curing the raw second layer; disposing the LED with the desired radiation shape below the vat; the vat having a translucent bottom or a transparent bottom; sintering the cured first and second layers and the plurality of attached cured layers; subjecting the cured first and second layers and the plurality of attached cured layers to a hot isostatic press (HIP) process; providing the slurry as having a viscosity of at least 2 Pascal-seconds; providing the magnetic field in the range of 0.5 to 4 Teslas; wherein creating the slurry comprises homogenously mixing the magnetic material, the photopolymerizing material and solvent; providing the magnetic powder material comprising at least one rare earth metal; providing the magnetic powder material comprising neodymium, iron, and boron; and providing the magnetic powder material comprising at least one of dysprosium and terbium.

In another form, the present disclosure provides a magnet containing a plurality of layers comprising magnetic powder material. Each layer comprises cured photosensitive resin.

Additional features of the magnet may include, but are not limited to: the magnet having an anisotropic orientation; the magnet comprising at least one rare earth metal; each layer being in the range of 10 to 1000 micrometers thick; the magnet comprising neodymium, iron, and boron; and the magnet comprising dysprosium and/or terbium.

In addition, the present disclosure provides a magnet formed by any version of the method disclosed herein.

The above features and advantages, and other features and advantages of the present disclosure, will be readily apparent from the following detailed description of the many aspects of the present disclosure when taken in connection with the accompanying drawings and appended claims.

### BRIEF DESCRIPTION OF THE DRAWINGS

The drawings are provided for illustration purposes only and are not intended to limit this disclosure or the claims appended hereto.

FIG. 1A is a plan view of an exemplary magnet, in accordance with the principles of the present disclosure;

FIG. 1B is a perspective view of the magnet of FIG. 1A, according to the principles of the present disclosure;

FIG. 1C is a cross-sectional side view of a portion of the magnet of FIGS. 1A-1B, taken along the line 1C-1C in FIG. 1B, in accordance with the principles of the present disclosure;

FIG. 2 is a block diagram illustrating a method of forming a magnet, according to the principles of the present disclosure;

FIG. 3A is schematic cross-sectional view of an apparatus for forming the magnet of FIGS. 1A-1C at an initial step in a process of forming the magnet of FIGS. 1A-1C, in accordance with the principles of the present disclosure;

FIG. 3B is a schematic plan view of the apparatus of FIG. 3A, according to the principles of the present disclosure;

FIG. 3C is schematic cross-sectional view of the apparatus of FIGS. 3A-3B at a step in the process of forming the magnet of FIGS. 1A-1C after the step shown in FIG. 3A, according to the principles of the present disclosure;

FIG. 3D is schematic cross-sectional view of the apparatus of FIGS. 3A-3C at a step in the process of forming the magnet of FIGS. 1A-1C after the step shown in FIG. 3C, in accordance with the principles of the present disclosure;

FIG. 3E is schematic cross-sectional view of the apparatus of FIGS. 3A-3D at a step in the process of forming the magnet of FIGS. 1A-1C after the step shown in FIG. 3D, according to the principles of the present disclosure;

FIG. 3F is schematic cross-sectional view of the apparatus of FIGS. 3A-3E at a step in the process of forming the magnet of FIGS. 1A-1C after the step shown in FIG. 3E, in accordance with the principles of the present disclosure;

FIG. 3G is schematic cross-sectional view of the apparatus of FIGS. 3A-3F at a step in the process of forming the magnet of FIGS. 1A-1C after the step shown in FIG. 3F, according to the principles of the present disclosure; and

FIG. 3H is schematic cross-sectional view of the apparatus of FIGS. 3A-3G at a step in the process of forming the magnet of FIGS. 1A-1C after the step shown in FIG. 3G, in accordance with the principles of the present disclosure.

### DETAILED DESCRIPTION

The present disclosure provides a permanent magnet and a process for making permanent magnets in such a way that material loss is reduced. The process greatly reduces or eliminates the need for subsequent machining operations, and allows the magnetic material to be oriented in a desired direction without causing the loss of magnetic powder material.

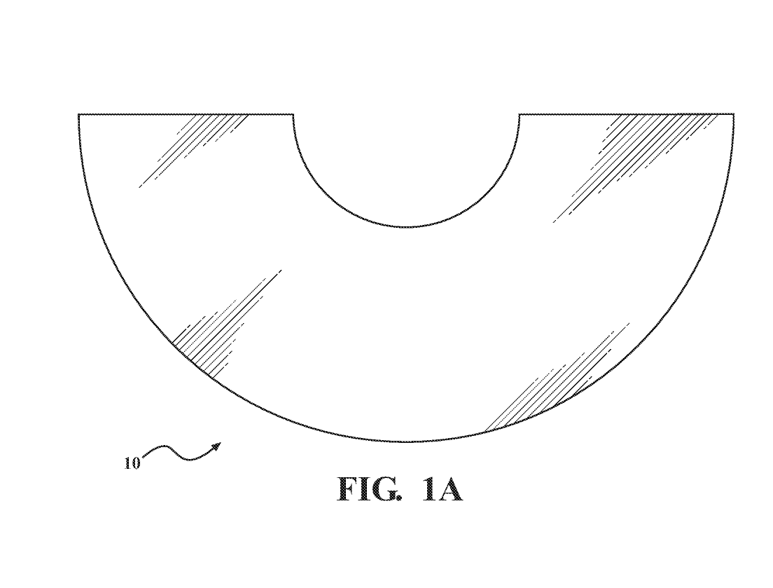

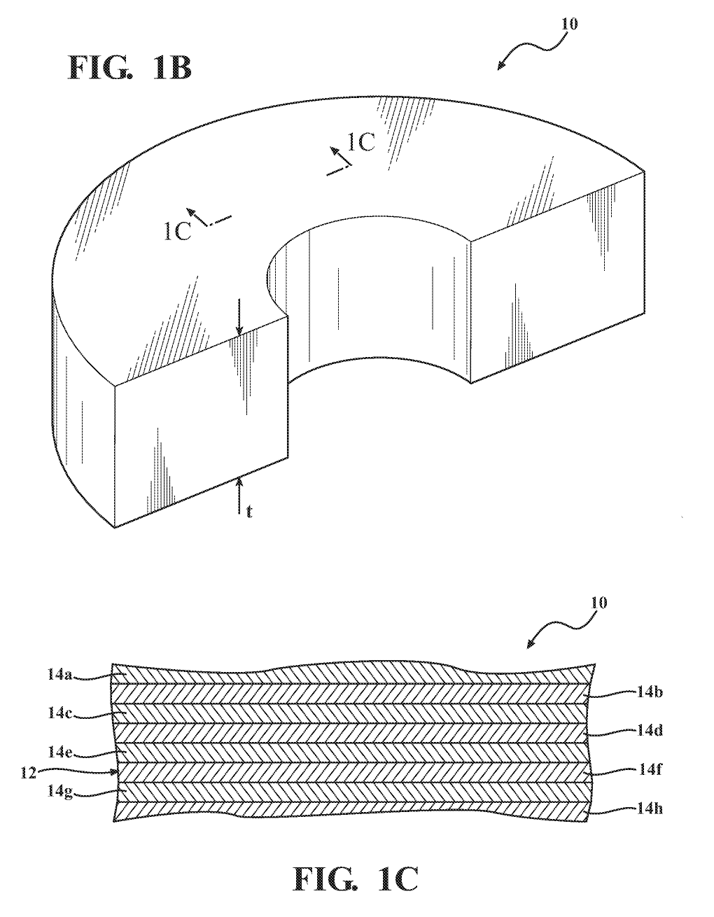

Referring now to FIGS. 1A-1B, a permanent magnet is illustrated and generally designated at 10. In this variation, the permanent magnet 10 has a three-dimensional half-annulus shape with a thickness t; however, the permanent magnet 10 could have any other desired shape, without falling beyond the spirit and scope of the present disclosure. The permanent magnet 10 could be useful in electric motors and the like, or in any other desired application.

The magnet 10 may be a ferromagnetic magnet, having an iron-based composition, and the magnet 10 may contain any number of rare earth metals. For example, the magnet 10 may have a Nd—Fe—B (neodymium, iron, and boron) configuration. The magnet 10 may also contain Dy (dysprosium) and/or Tb (terbium), if desired. It is also contemplated that the magnet 10 may comprise additional or alternative materials, without falling beyond the spirit and scope of the present disclosure.

Referring now to FIG. 1C, the permanent magnet 10 is formed from a plurality of layers 12 that each contain magnetic material. Each of the layers 14a, 14b, 14c, 14d, 14e, 14f, 14g, 14h of the plurality of layers 12 may be created by 3D-printing or otherwise disposing the layers 14a, 14b, 14c, 14d, 14e, 14f, 14g, 14h contiguously, layer by layer, to form the shape of the permanent magnet 10. Thus, the magnet 10 is created, one layer 14a, 14b, 14c, 14d, 14e, 14f, 14g, 14h at a time, into substantially the final net shape desired. Thought eight layers 14a, 14b, 14c, 14d, 14e, 14f, 14g, 14h are shown in FIG. 1C, any desired number of layers 14a, 14b, 14c, 14d, 14e, 14f, 14g, 14h may be provided. For example, many layers 14a, 14b, 14c, 14d, 14e, 14f, 14g, 14h, such as 300, may be provided.

Each layer 14a, 14b, 14c, 14d, 14e, 14f, 14g, 14h may have a height or thickness in the range of about 5-500 micrometers; for example, each layer 14a, 14b, 14c, 14d, 14e, 14f, 14g, 14h may have a height in a range of 3-100 micrometers. As such, if the magnet 10 may has a large plurality of layers, such as 300 layers, the magnet may have a resulting thickness t of about 3 mm, by way of example. Other thicknesses t could be in the range of about 1 to about 10 mm for electric motors, or any other desired magnet thickness t. Magnets used in wind mills are much bigger.

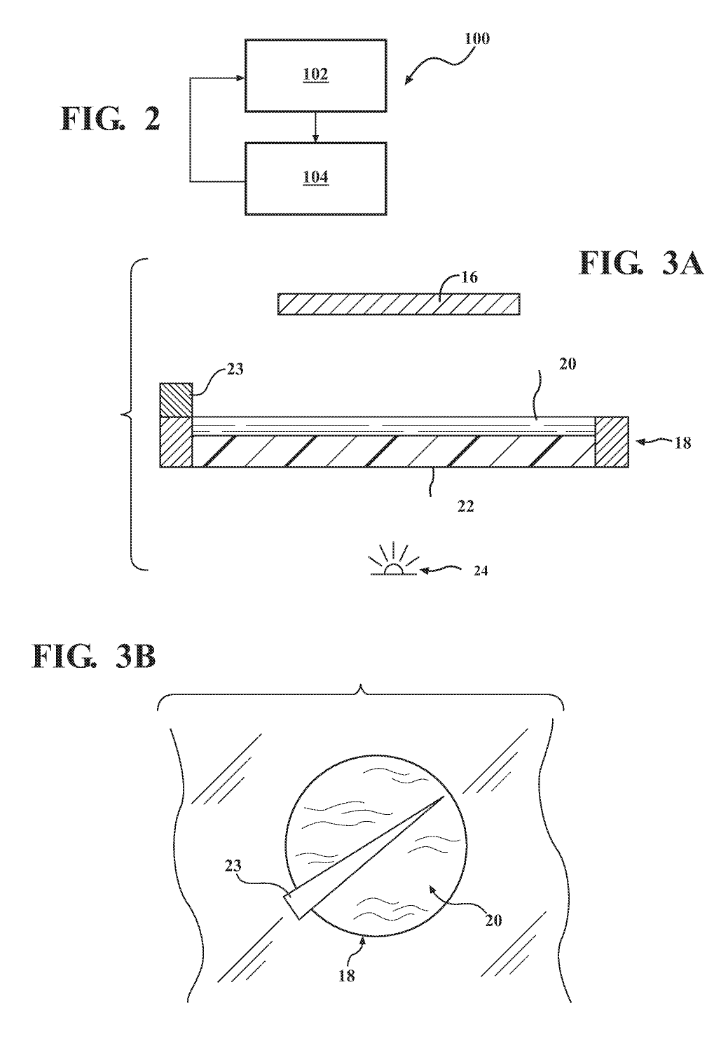

Referring now to FIG. 2, the present disclosure provides a method 100 of near net shape forming a magnet, such as the magnet 10. The method 100 includes a step 102 of forming a slurry comprising magnetic powder material and photopolymerizing material. The magnetic powder material may include any desired magnetic powders, such as powders of the materials described above (iron, neodymium, iron, boron, dysprosium, terbium, etc.) The slurry may further contain a solvent for making the slurry viscous and flowing. The solvent may be water-based, but in a preferable form, the solvent is an organic-based solvent such as kerosene or alcohol (e.g., ethanol or methanol) to avoid oxidizing the magnetic powder material. Typical magnet binders, which may be organic or inorganic, may be included, but are optional. The binder material may assist with holding the magnet powder material together until heat treated and/or sintered. The binder material may be a polymer-based, non-magnetic material configured to enable adherence together of powder particles of the magnetic powder material. In some forms, the slurry may be viscous, such as having a viscosity of at least 2 or 3 Pascal-seconds, or much higher. The slurry may be formed by homogenously mixing the magnetic material and the photopolymerizing material, as well as a solvent.

The photopolymerizing material is included to allow the magnetic slurry to be formed into layers and cured with electromagnetic radiation, such as light, which will be explained in further detail below. The photopolymerizing material, or photosensitive resin or photopolymer, is a composition that can be selectively polymerized and/or crosslinked upon image-wise exposure by light radiation or other electromagnetic radiation, such as ultra-violet light.

In general, photopolymers may contain several components including binders, photoinitiators, additives, chemical agents, plasticizers, and colorants. In some forms, photopolymerizing material formulations may comprise polymers, oligomers, monomers, and/or additives. Polymer bases for photopolymers may include acrylics, polyvinyl alcohol, polyvinyl cinnamate, polyisoprene, polyamides, epoxies, polyimides, styrenic block copolymers, nitrile rubber, or other bases. In some examples, the polymeric base may be dissolved in the solvent carrier, such as the organic solvent used in the slurry. An included monomer may comprise multifunctional acrylates and methacrylates combined with a non-polymeric component in order to reduce volume shrinkage.

In some variations, the photopolymer may consist of 50-80% of a binder or oligomer, such as: styrene family oligomers (e.g., oligomer of styrene-tetramer-alpha cumyl end group, α-methyl styrene-dimer (1), α-methyl styrene-tetramer, etc.); methacrylates (e.g., acrylic acid oligomers, methyl methacrylate oligomers, methyl methacrylate tetramer, etc.); vinylalcohols (e.g., vinyl alcohol trimer, vinylacetate trimer, vinylacetate oligomer, etc.); olefines (e.g., poly isobutylene); glycerols (e.g., triglycerol); polypropylene glycols (e.g., poly propylene glycol (dihydroxy terminated), etc.).

The photopolymer may also consist of one or more monomers, such as one based on an acrylate or methacrylate, for example, as 10-40% of its composition. In the process of polymerization, multifunctional monomers and/or monofunctional monomers. Multifunctional monomers can act as both diluents and cross linkers, whereas monofunctional monomers can be either diluents or cross linkers. Some of examples of monofunctional and multifunctional monomers include acrylic acid, methacrylic acid, isodecyl acrylate, n-vinyl pyrrolidone, trimethylopropane triacrelate (TMPTA), ethoxylated TMPTA, trimethylepropane trimethacrylate, and hexanediol diacrylate.

Photoinitiators are also included in the photopolymerizing material, which may convert light energy into chemical energy by forming free radicals or cations upon electromagnetic radiation (such as visible light or ultraviolet) exposure. Upon such exposure, the photoinitiators break into two or more particles and at least one of the particles will react with the monomers or oligomers and bind them together.

Photoinitiators may be free radicals or cationic photoinitiators, by way example. In free radical photopolymerization, radicals or ions break off the initiators when electromagnetic radiation reacts, and ions then start reacting with monomers to initiate polymerization. In cationic reaction, strong acid is released from the initiator, which starts a bonding process. Some examples of free radical photoinitiators include isopropylthioxanthone, benzophenone, and 2,2-azobisisobutyronitrile. Examples of cationic photoinitiators include diaryliodonium salts, and triarylsulfonium salts.

Other examples of photopolymerizing materials that can be used or combined with others include hydroxycyclohexylphenyl ketones with acrylates, titanocene photoinitiator with epoxide resin or acrylates, N-methyl-2-pyrrolidone (NMP) with tetrahydrofuran (THF), and esters of cinnamic acid (C₉H₈O₂). Photopolymer resins with mechanical properties similar to engineering plastics, such as ABS, nylon, and polycarbonate, may also be used in the slurry.

Once the slurry is created, the method 100 includes a step 104 of creating a raw (uncured) first layer 14a′ from the slurry. This may include 3D printing the raw first layer 14a′ or the raw first layer 14a′ may be created from the slurry in any other suitable manner.

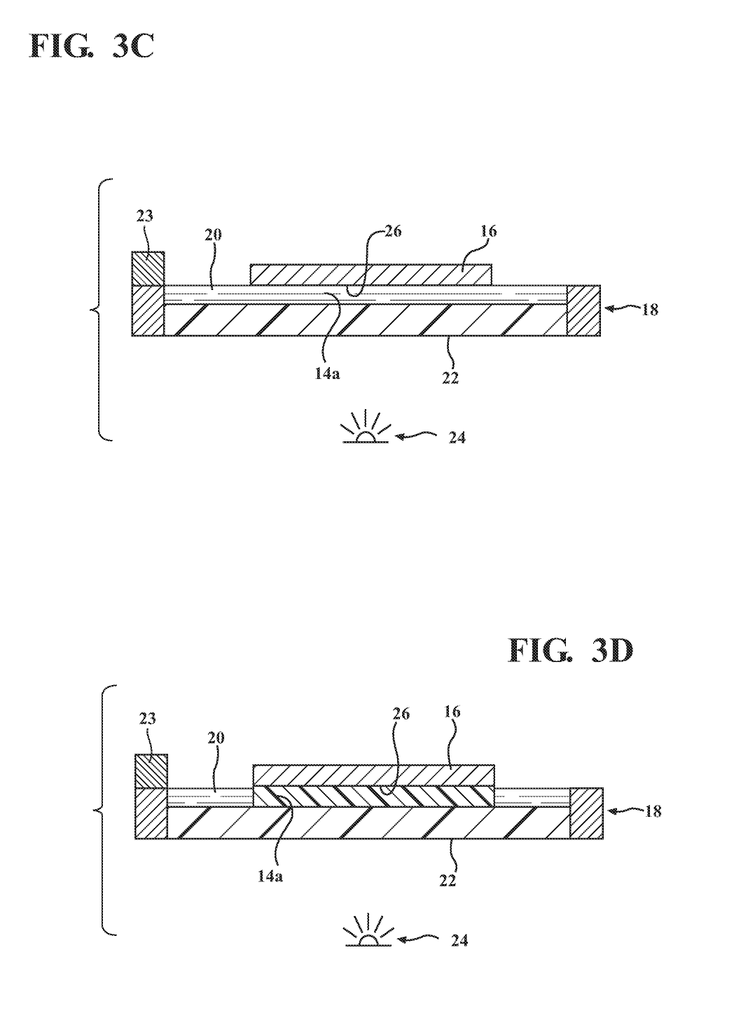

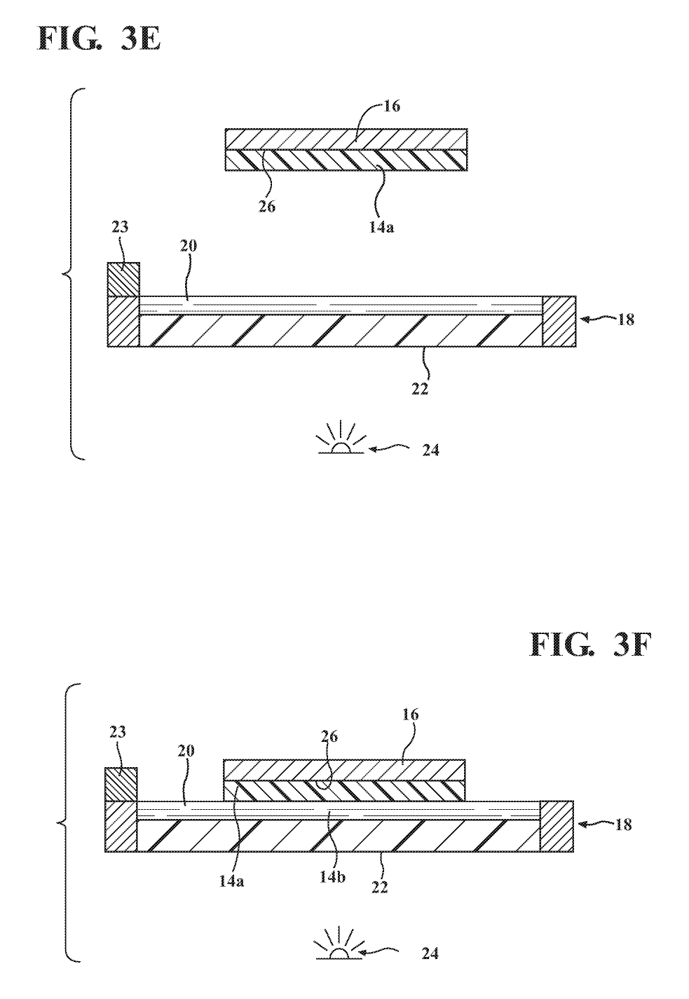

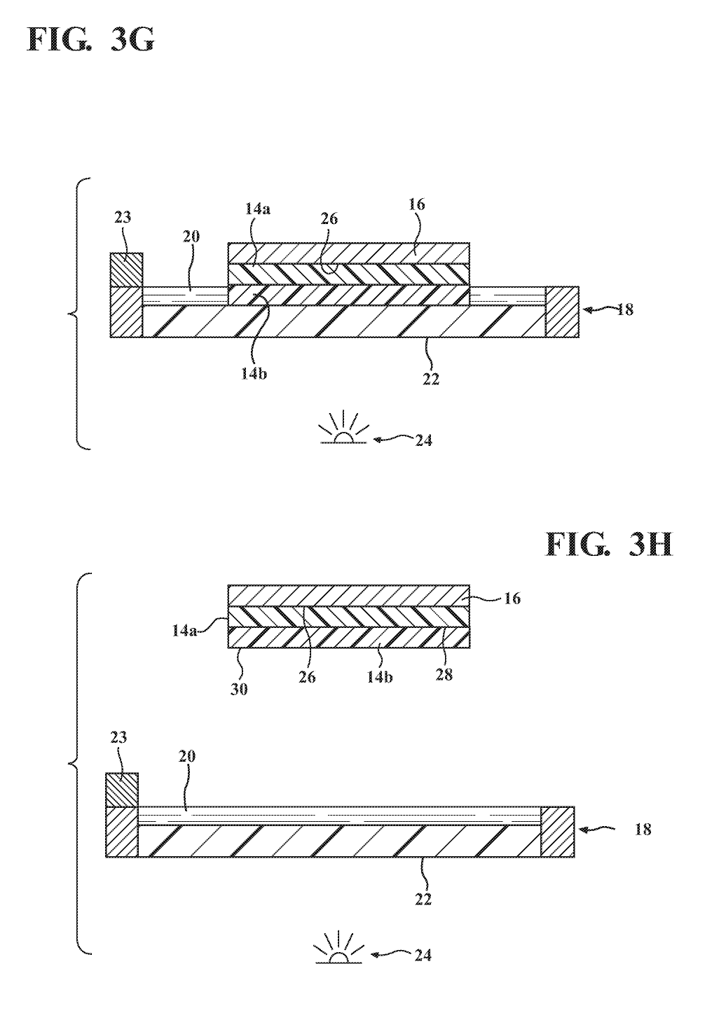

In one form, referring to FIG. 3A, a base 16 is provided and a shallow vat 18 is provided under the base, where the slurry is contained within the vat 18 and designated at reference numeral 20. The bottom 22 of the vat 18 is formed of a transparent or translucent material, and a source of electromagnetic radiation is located under the vat 18 adjacent to the bottom 22. In the illustrated example, the source of electromagnetic radiation is a visible light source, such as one or more light-emitting diodes (LED) 24; but in the alternative, the source of electromagnetic radiation could provide ultraviolet light, infrared light, or any other desired source that is effective to cure the photopolymer.

In some forms, a light modulator may be included to vary the intensity of the light 24, and an exposure field may be generated on the bottom 22 of the tank to create a desired shape of the particular layer that is going to be cured next. The desired shape is determined by a computer aided design (CAD) input for 3-D printing or manufacturing and implemented by the exposure field in the bottom 22 through which each layer is cured by the light 24.

Referring to FIGS. 3A-3B, the flat shallow vat 18 holds the slurry 20 while the slurry layer (having a thickness in the range of several micrometers to one millimeter) is evenly applied on the flat vat with a sharp knife 23.

Referring to FIG. 3C, the method 100 may include lowering the base 16 toward and into the slurry 20 to dispose a raw first layer 14a′ onto the base 16 prior to curing the raw first layer 14a′. The raw first layer 14a′ is then disposed between the bottom 22 of the vat 18 and an underside 26 of the base 16.

Referring to FIG. 3D and with continued reference to FIG. 2, the method 100 then includes a step 104 of curing the raw first layer 14a′ with electromagnetic radiation to form a cured first layer 14a that is attached to the underside 26 of the base 16. In preferred variations, the method 100 includes applying a magnetic field to the raw first layer 14a′ while curing the raw first layer 14a′. The magnetic field may be provided with magnetism in the range of 0.5 to 4 Teslas, or about 1-3 Teslas, by way of example. Providing the magnetic field orients the magnetic powder materials in slurry of the raw first layer 14a′ to be oriented in a desired direction while the layer 14a′ is being cured, and then the magnetic materials are locked into position after the curing. When the magnetic field is applied during the curing step for each layer, the magnet 10 has an anisotropic orientation that may be, for example, 30% stronger in magnetic properties in a specific direction than an otherwise similar isotropic magnet. The layer 14a is a cured shape based on an image of the electromagnetic radiation formed by computer aided design (CAD) input for the magnet.

Referring now to FIG. 3E, after curing the raw first layer 14a′ to form the cured first layer 14a, the base 16 may be lifted from the vat 18 with the cured first layer 14a attached to the underside 26 of the base 16.

Referring to FIG. 3F and with continued reference to FIG. 2, the method 100 then iterates back to step 102 to form another layer from the slurry. Thus, in the example of FIGS. 3A-3F, the method 100 may include removing the residual of the prior leftover slurry and then applying a fresh layer of slurry to form the raw second layer of slurry by scrubbing with a thin knife on the flat vat 18, lowering the base 16 with the attached cured first layer 14a toward and into the slurry 20 to dispose a raw second layer 14b′ onto the cured first layer 14a prior to curing the raw second layer 14b′. The raw second layer 14b′ is then disposed between the bottom 22 of the vat 18 and the cured first layer 14a.

Referring to FIG. 3G and with continued reference to FIG. 2, the method 100 again proceeds to the step 104 of curing the layer, which is this time, the raw second layer 14b′. Like the raw first layer 14a′, the raw second layer 14b′ is cured with electromagnetic radiation, such as the LED light source 24, to form a cured second layer 14b that is attached to the cured first layer 14a. Again, in preferred variations, the method 100 includes applying a magnetic field to the raw second layer 14b′ while curing the raw second layer 14b′ to orient the magnetic powder material contained in the slurry in the desired direction while the layer 14b′ is being cured.

Referring now to FIG. 3H, after curing the raw second layer 14b′ to form the cured second layer 14b, the base 16 may be lifted from the vat 18 with the cured first layer 14a still attached to the underside 26 of the base 16 and with the cured second layer 14b attached to the underside 28 of the cured first layer 14a, in the manufacturing orientation illustrated in FIG. 3H.

The method 100 may iteratively repeat steps 102 and 104 to form additional layers on the other layers to form the entire magnet 10. If needed, additional volume of the slurry 20 may be added to the vat 18. Thus, the plurality of additional layers 14c, 14d, 14e, 14f, 14g, 14h may be disposed at first in raw form, layer by layer, onto the underside 30 of the cured second layer 14b, with each additional layer being formed from the slurry 20, and in between disposing each additional layer, curing with the light 24 a most recent disposed additional layer, to form a plurality of attached cured layers 14c, 14d, 14e, 14f, 14g, 14h illustrated in FIG. 1C. As each layer is cured, a magnetic field may be applied to it during the light-curing process, as explained above.

After forming each of the cured layers 14a, 14b, 14c, 14d, 14e, 14f, 14g, 14h by disposing them in raw form and then curing them to form the magnet 10, the magnet 10 (including all of its layers 14a, 14b, 14c, 14d, 14e, 14f, 14g, 14h) may then be sintered and subjected to a hot isostatic press (HIP) process.

Thus, a magnet 10 formed that contains a plurality of layers 14a, 14b, 14c, 14d, 14e, 14f, 14g, 14h comprising magnetic powder material, where each layer 14a, 14b, 14c, 14d, 14e, 14f, 14g, 14h also comprises cured photosensitive resin.

The method 100 of forming the magnet 10 may include further optional steps, such as a step of initial preparation, including inspection and weighing of the starting materials for the desired material compositions. The method may also include vacuum induction melting and strip casting of the starting materials to form thin pieces (less than one mm) of several centimeters in size. Hydrogen decrepitation may then be performed, where the thin pieces absorb hydrogen at about 25° C. to about 300° C. for about 5 to about 20 hours and then are dehydrogenated at about 200° C. to about 400° C. for about 3 to about 25 hours. The method may also include pulverization, which may include hammer milling and grinding and/or mechanical pulverization or nitrogen milling (if needed) to form fine powder suitable for further powder metallurgy processing.

The method may include mixing middling powder, milling, mixing fine powder, and blending different magnetic powders. For example, if the magnet 10 is being produced is based on a Nd—Fe—B configuration where at least some of the Nd is to be replaced by Dy or Tb, constituent powders may include the aforementioned iron-based powder containing Dy or Tb, as well as an Nd—Fe—B-based powder. In one form, such as for car or truck applications involving traction motors, the finished rare earth permanent magnets will have Dy by weight as high as about 8 or 9 percent. In other applications, such as wind turbines, the bulk Dy or Tb concentration may need to be on the order of 3 to 4 percent by weight. In any event, the use of permanent magnets in any such motors that could benefit from improved magnetic properties (such as coercivity) are deemed to be within the scope of the present disclosure. Additional constituents—such as the binders referred to above—may also be included into the mixture produced by blending, although such binders should be kept to a minimum to avoid contamination or reductions in magnetic properties. In one form, the blending may include the use of an iron-based alloy powder of Dy or Tb (for example, between about 15 percent and about 50 percent by weight Dy or Tb) being mixed with an Nd—Fe—B-based powder.

The magnetic powder may be screened for size classification and then mixed with other alloying powders for the final desired magnetic material composition, along with binders (if desired, as explained above). The photopolymerizing material may also be mixed together with the magnetic material and any other binders, to form a well-mixed, or homogenous, powder material. The solvent may then be added to form the slurry.

Thereafter, the plurality of layers 12 of magnet powder material are printed, such as by a three-dimensional printer, in step 102, as explained above. This may include use of the method involving the base 16 and the vat 18, or use of another 3D printing method. As described above, the step 102 of printing the layers 14a, 14b, . . . may include printing the plurality of layers 12 into a desired final shape of the magnet, with little cutting and machining required thereafter. Each layer 14a, 14b, 14c, 14d, 14e, 14f, 14g is preferably cured with the light 24 while a magnetic field is being applied to the respective layer to substantially orient the magnetic powder material in a desired direction to create an anisotropic magnet. Thus, the magnetic powder material is aligned under a magnetic field, which may be in the range of about 0.5 to 4 Tesla, and preferably about 2 Tesla. The magnetic field will cause the individual magnetic particles of the mixture to align so that the finished magnet 10 will have a preferred magnetization direction. Thus, the magnet powder material may be provided in an anisotropic orientation.

In some forms, the cured layers 14a, 14b, 14c, 14d, 14e, 14f, 14g may be heated to a hardening temperature that is lower than the sintering temperature. For example, the hardening temperature may be less than 400 degrees C., however, this step may not be necessary in all forms. Hardening heating may result in “hardened green parts” or “brown parts” that are still not in final strength and microstructure because they should preferably undergo sintering to fully harden them. After hardening, the magnet 10 is slightly hardened, but not as hard as the magnet 10 would be after sintering. However, in this step, most of the binder is burned off, and left a pure magnet composition and microstructure that is desired for improved magnetic properties.

If sintering is used, the magnet 10 is sintered at a temperature in the range of about 750 to about 1100 degrees C. The sintering may be performed in vacuum for about 1 to about 30 hours and aged, if needed, another heat treatment may be performed at about 300 degrees C. to about 700 degrees C. for about 3 to about 20 hours in vacuum.

Sintering can be performed in vacuum or in an inert atmosphere (for example, N₂ or Ar) to prevent oxidation. Typical sintering vacuum is in the range of about 10⁻³ and about 10⁻⁵ Pascals to achieve up to 99 percent theoretical density. Longer sintering times can further improve the sintered density. If the sintering time is too long, it may negatively impact both mechanical and magnetic properties due to over grown grains in microstructure. As with other forms of powder metallurgy processing, a cooling schedule may be used, where the sintered component is cooled over the course of numerous hours. Sintering 104 may also include subjecting the layers 12 to a SiC heating element and high-powered microwaves.

Sintering is used to promote metallurgical bonding through heating and solid-state diffusion. As such, sintering—where the temperature is below that needed to melt the magnetic powder material—is understood as being distinct from other higher temperature operations that do involve melting of the powder material. Before sintering, a heat isostatic pressing (HIPping) may be used for improving the magnet density and simplifying the subsequent sintering process.

Additional secondary operations after the sintering may also be employed, including minor machining and surface treatment or coating.

In addition, HIPping may be applied to increase magnet density, or minimize porosity before or after sintering. HIPping may include subjecting the magnet 10 to a hot isostatic press (HIP) process. In an alternative configuration, hot forging may be used instead of the HIP process. In some variations, minor machining, such as polishing (for example, with ceramic or metallic powder) and/or grinding may be performed, if desired.

Surface treatment may then be applied, for example, the addition of an oxide or related coating in certain situations. For example, a protective layer or coating may be added. The protective coating may be applied after sintering.

It will be apparent that modifications and variations are possible without departing from the scope of the invention defined in the appended claims. More specifically, although some aspects of the present disclosure are identified herein as preferred or particularly advantageous, it is contemplated that the present invention is not necessarily limited to these preferred aspects of the invention.

1. A method of forming a magnet, the method comprising:
forming a slurry comprising magnetic powder material and photopolymerizing material;
creating a raw first layer from the slurry;
curing the raw first layer with electromagnetic radiation to form a cured first layer;
after curing the raw first layer, creating a raw second layer from the slurry in contact with the cured first layer; and
curing the raw second layer with electromagnetic radiation to form a cured second layer, the cured second layer being attached to the cured first layer.

2. The method of claim 1, further comprising applying a magnetic field to the raw first layer while curing the raw first layer, and applying a magnetic field to the raw second layer while curing the raw second layer, to substantially orient the magnetic powder material in a desired direction.

3. The method of claim 2, further comprising disposing a plurality of additional layers, layer by layer, onto the cured second layer, each additional layer being formed from the slurry, and in between disposing each additional layer, curing with light a most recent disposed additional layer to form a plurality of attached cured layers.

4. The method of claim 3, the slurry further comprising an organic-based solvent.

5. The method of claim 3, wherein the electromagnetic radiation is visible light.

6. The method of claim 5, further comprising providing the visible light with a light-emitting diode (LED).

7. The method of claim 6, further comprising:
providing a base;
providing a vat holding the slurry;
lowering the base toward the slurry to dispose the raw first layer onto the base prior to curing the raw first layer;
lifting the base after curing the raw first layer;
removing residual slurry;
applying a second fresh layer of the slurry by scrubbing with a knife;
lowering the base toward the slurry to dispose the raw second layer onto the cured first layer prior to curing the raw second layer; and
lifting the base after curing the raw second layer.

8. The method of claim 7, further comprising disposing the LED below the vat, the vat having one of a translucent bottom and a transparent bottom.

9. The method of claim 3, further comprising:
sintering the cured first and second layers and the plurality of attached cured layers; and
subjecting the cured first and second layers and the plurality of attached cured layers to a hot isostatic press (HIP) process,
wherein creating the slurry comprises homogenously mixing the magnetic material and the photopolymerizing material.

10. The method of claim 3, further comprising:
providing the slurry as having a viscosity of at least 3 Pascal-seconds; and
providing the magnetic field in the range of 0.5 to 4 Teslas.

11-12. (canceled)

13. The method of claim 3, further comprising providing the magnetic powder material comprising at least one rare earth metal.

14-15. (canceled)

16. A magnet containing a plurality of layers comprising magnetic powder material, each layer comprising cured photosensitive resin.

17. The magnet of claim 16, wherein the magnet has an anisotropic orientation.

18. The magnet of claim 17 comprising at least one rare earth metal, each layer being in the range of 10 to 100 micrometers thick.

19. The magnet of claim 18 comprising neodymium, iron, and boron.

20. The magnet of claim 19, further comprising at least one of dysprosium and terbium.

21. The method of claim 13, further comprising providing the magnetic powder material comprising neodymium, iron, and boron.

22. The method of claim 13, further comprising providing the magnetic powder material comprising at least one of dysprosium and terbium.

23. A magnet formed by the method of claim 1.

24. A magnet formed by the method of claim 2.
